(19) United States
(12) Patent Application Publication
(10) Pub. No.: US 2013/0055988 A1
(43) Pub. Date: Mar. 7, 2013

(54) COMPONENT OF A FUEL INJECTION SYSTEM AND FUEL INJECTION SYSTEM

(71) Applicants: Martin Maier, Moeglingen (DE); Nikolaus Hautmann, Ditzingen (DE)

(72) Inventors: Martin Maier, Moeglingen (DE); Nikolaus Hautmann, Ditzingen (DE)

(21) Appl. No.: 13/542,063

(22) Filed: Jul. 5, 2012

(30) Foreign Application Priority Data
Jul. 6, 2011 (DE) 10 2011 078 734.8

(51) Int. Cl. F02M 69/50; B05B 1/00

(52) U.S. Cl. 123/446; 239/589

(57) ABSTRACT

A component of a fuel injection system, designed in particular as a fuel distributor or a fuel injector, includes a base body on which at least one electric line is provided. The electric line is applied to the base body by plasma coating. In addition, a fuel injection system, used in particular for motor vehicles, includes a fuel distributor and multiple fuel injectors mounted on the fuel distributor.

### CROSS-REFERENCE TO RELATED APPLICATION

The present application claims priority to Application No. DE 10 2011 078 734.8, filed in the Federal Republic of Germany on Jul. 6, 2011, which is expressly incorporated herein in its entirety by reference thereto.

### FIELD OF INVENTION

The present invention relates to a component of a fuel injection system which is designed, in particular, as a fuel distributor or fuel injector, and a fuel injection system. In particular, the present invention relates to the area of fuel injection systems for motor vehicles.

### BACKGROUND INFORMATION

A method for manufacturing fuel distributors is known from German Application No. DE 101 36 050 A1. The fuel distributors here include a cavity, which is connected to a fuel source via a connector, and via which a number of injectors may be supplied with fuel. In this case, a pre-assembled module of an injector is integrated into the cavity using a central plug-in connector via an integral joint during the manufacture of the fuel distributor, the injectors being electrically connected at the same time. The electrical contacts in the fuel distributor may be designed as a lead frame forming conductor paths.

The method known from German Application No. DE 101 36 050 A1 and the fuel distributor manufactured using the known method have the disadvantage that several process steps are required for the assembly and contacting. In addition, additional tools are needed for manufacturing the additional parts, in particular stamping tools for forming the lead frames. Furthermore, the electrical connections require a certain amount of space, which claims installation space. In addition, holding functions must be ensured for the lead frame and the central plug. Furthermore, the current-conducting parts must be covered with additional parts, in particular a cover or an additional extrusion coating to ensure insulation and protection against contact. In addition to the high space requirement and the high costs, undesirable noise, in particular at the component plug, may be generated by vibrations.

It is also conceivable to use a cable harness instead of a lead frame. However, in that case, holding functions must be ensured for the cable harness. In addition, a cable harness is susceptible to damage, for example, by gnawing martens, when installed in the engine compartment.

An example of a method for plasma coating is known from German Application No. DE 10 2006 061 435 A1. Here, a method and a device for extruding, in particular, a conductor path, an electrical component having a conductor path, and a metering device are described. In the known method for extruding a path, in particular a conductor path, onto a substrate, a spray lance extending longitudinally is used, which is moved relative to the substrate at a relative velocity. An ionizable gas is supplied to the spray lance under atmospheric conditions, the gas being ionized by an electric arc generated in the spray lance, so that cold plasma having a plasma temperature of less than 3000 K is produced. Furthermore, a powder is introduced into the spray lance with the aid of a carrier gas; the powder is entrained by the plasma toward a discharge opening of the spray lance on the front face side, exits there and impinges on the substrate. Comparatively little energy is introduced by the cold plasma into the material to be applied, so that the latter is very gently applied to the substrate. Even thin substrate layers of <1 mm are not destroyed during the spray process.

### BRIEF SUMMARY OF THE INVENTION

The component of a fuel injection system and the fuel injection system according to the present invention have the advantage over the related art that an improved design is made possible. In particular, a cost- and/or installation space-optimized approach for ensuring an electrical connection is made possible.

It is advantageous that the base body is at least partially made of one plastic part, that an electrically conductive contact element is provided, that the electrically conductive contact element is at least partially inserted into the plastic part, and that the contact element is electrically connected to the electric line. If the component is designed, for example, as a fuel injector, an actuator, in particular a solenoid of a magnetic actuator, may be connected via the contact element. Furthermore, a contact point which, together with another contact point on another component, enables a detachable electrical connection may be implemented with the aid of such a contact element. A modular design is thus possible, in which multiple components are assembled, for example, to form a fuel injection system. Each of these components may then have one or more electric lines which are applied to the base body of the particular component by plasma coating.

It is also advantageous that the electrically conductive contact element has a connecting section and that the electric line is applied by plasma coating to the connecting section of the electrically conductive contact element for forming the electrical connection. When forming the electric line, the device for plasma coating may be guided either over the base body or over the electrically conductive contact element provided on the base body in order to form an uninterrupted electric line. This makes manufacturing of the electric line particularly easy, since no additional contacting procedures such as soldering, welding, bonding, or conductive gluing is necessary. The electric lines may thus be applied directly to the contact elements and to an insulating base body.

Depending on the configuration, the electrically conductive contact element may, however, also be electrically connected to the plasma-coated electric line by soldering, welding, bonding, or conductive gluing.

In addition, it is advantageous that the connecting section of the contact element has at least one claw element which is connected to the plastic part in a form-locked and/or integral manner. A reliable mechanical connection of the contact element with the plastic part is thus achieved. A mechanical load on the electric line bridging the plastic part and the contact element and applied by plasma coating is thus reduced.

In addition, it is also advantageous that the claw element is introduced into the plastic part by an insulation displacement connection, or that the claw element is pressed into the plastic part. The mechanical stability may thus be further improved. Depending on the configuration, a cold contacting technique may also be thereby implemented.

It is, however, also advantageous that the electrically conductive contact element has a spring clip, which is pre-stressed against the electric line for forming the electrical connection. Pressure contacting may thus be implemented. This contacting also has the advantage that a certain relative motion is made possible. It allows, for example, different thermal expansions between the base body and the electrically conductive contact element to be equalized. Furthermore, the mechanical load of the electric line, applied by plasma coating, in the area of the contact point to the electrically conductive contact element may be reduced if vibrations or the like occur.

It is also advantageous that the electric line is at least partially coated by an electrically insulating protective layer. The electric line may thus be protected against contact, short-circuiting, corrosion, or mechanical wear such as abrasion. The protective layer may be designed as a protective lacquer. However, it is also possible that the electric line is covered for this purpose, at least partially, by an electrically insulating extrusion coating, in particular by a full or partial extrusion coating. An additional cover cap is also conceivable for protecting the electric line.

In addition, it is advantageous that the base body is made at least partially of at least one electrically insulating material, and that the electric line is applied directly to the electrically insulating material by plasma coating. In principle, the base body may be first coated using an electrically insulating layer, on which the electric line is applied by plasma coating. Directly applying the electric line to the base body by plasma coating, however, has the advantage that manufacturing steps may be saved. Plasma coating makes it possible to apply the electric line even in the case of challenging geometric contours. The electric line may then be implemented in the form of a three-dimensional curve on the appropriately shaped base body. Since the electric line may be applied subsequently to the base body, i.e., after the manufacture of the base body, the pressurized base body, for example, is not mechanically weakened in this way. This is advantageous in particular in the case of a fuel distributor, so that the electric line may be applied to a base body designed as a rail base body or a rail tube.

It is furthermore advantageous that a central plug is provided, a plug base body of the central plug is extruded onto the base body of the fuel distributor or integrated therein, and that the electric lines are electrically connected to contact elements of the central plug. A space-saving configuration is thus possible.

It is furthermore advantageous that one of the electric lines is used as a shared ground line for the fuel injectors and that the shared ground line is formed comb-like on the base body via plasma coating. The ground line may thus be designed as a shared path. If four fuel injectors are connected, the number of contact elements of the central plug may thus be reduced from eight to five, for example. The contact elements of the central plug may be designed as pins.

### BRIEF DESCRIPTION OF THE DRAWINGS

FIG. 1 shows a fuel injection system having a fuel distributor and multiple fuel injectors in a sectional schematic illustration corresponding to one exemplary embodiment of the present invention.

FIG. 2 shows a component of the fuel injection system illustrated in FIG. 1 in a sectional schematic illustration corresponding to one exemplary embodiment of the present invention.

FIG. 3 shows the section illustrated in FIG. 2 of a component of a fuel injection system corresponding to another exemplary embodiment of the present invention.

FIG. 4 shows the section illustrated in FIG. 2 of a component of the fuel injection system corresponding to yet another exemplary embodiment of the present invention.

FIG. 5 shows the component illustrated sectionally in FIG. 4 in a schematic sectional illustration along the section line identified by V-V.

FIG. 6 shows a wiring diagram for illustrating the electric lines of a fuel injection system corresponding to one exemplary embodiment of the present invention.

FIG. 7 shows a wiring diagram for illustrating the electric lines of a fuel injection system corresponding to another exemplary embodiment of the present invention.

### DETAILED DESCRIPTION

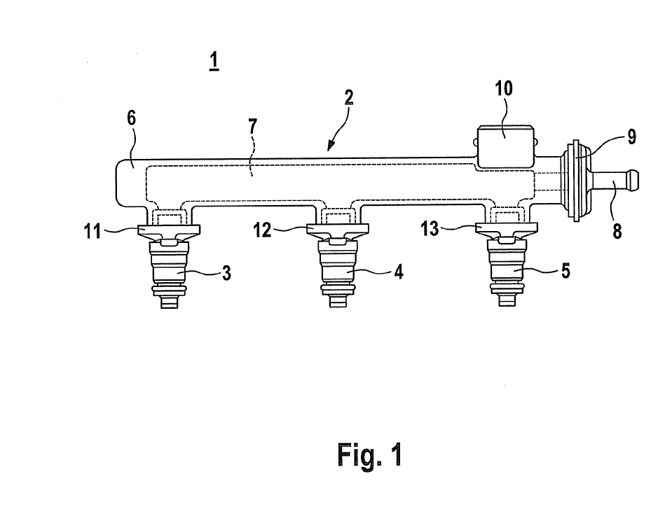

FIG. 1 shows a fuel injection system 1 having a fuel distributor 2 and multiple fuel injectors 3, 4, 5 in a schematic sectional illustration corresponding to one exemplary embodiment of the present invention. Here, fuel distributor 2 and fuel injectors 3, 4, 5 represent components 2, 3, 4, 5 of fuel injection system 1. Additional components or additional parts may be provided here. In addition, fuel distributor 2 and fuel injectors 3, 4, 5 may also be manufactured and sold independently from each other. Fuel injection system 1 and components 2 through 5 are suitable in particular for motor vehicles. Fuel injection system 1 according to the present invention and components 2 through 5 according to the present invention are, however, also suitable for other applications.

Fuel distributor 2 has a pipe-shaped base body 6, in which a cavity 7 is formed. Fuel may be conducted into cavity 7 of base body 6 via a fuel connection 8. A filter element 9 may be provided between fuel connection 8 and pipe-shaped base body 6.

Pipe-shaped base body 6 is preferably entirely or partially made of a plastic part 6. Base body 6 is thus formed at least partially from at least one electrically insulating material. Furthermore, a central plug 10, which is extruded onto base body 6 of fuel distributor 2, is provided on fuel distributor 2.

Fuel injectors 3, 4, 5 are connected to pipe-shaped base body 6 of fuel distributor 2 via suitable connecting elements 11, 12, 13.

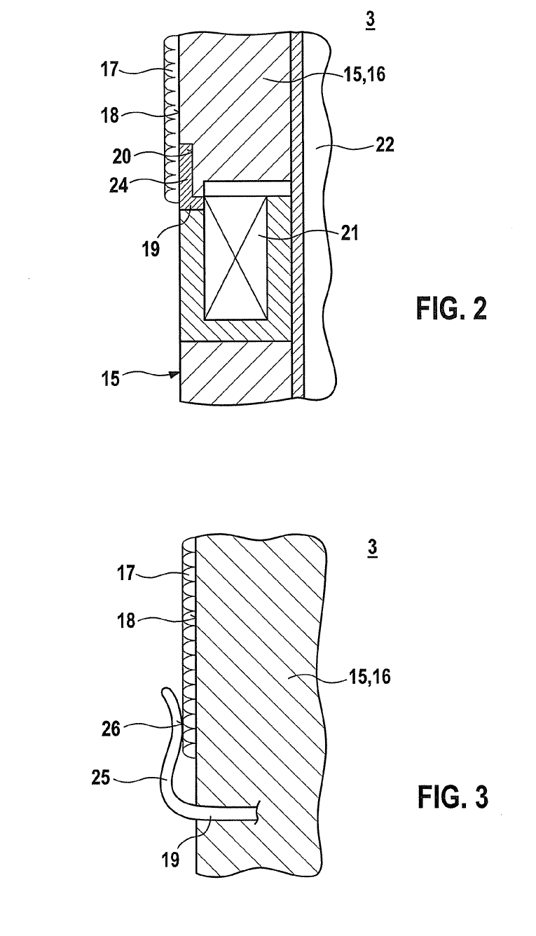

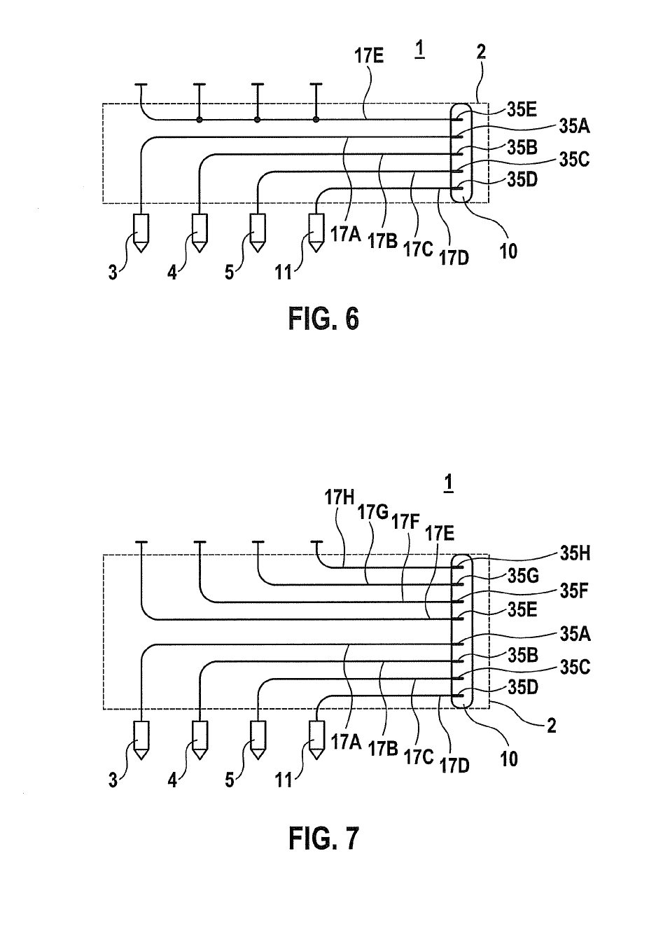

The design of fuel distributor 2 and of fuel injectors 3, 4, 5, which represent components 2 through 5 of fuel injection system 1, is described in greater detail with reference to FIGS. 2 through 7. FIGS. 2 through 5 describe the design using the example of component 3 designed as fuel injector 3, and FIGS. 6 and 7 illustrate possible wiring diagrams of fuel injection system 1 having components 2 through 5.

FIG. 2 shows a component 3 of fuel injection system 1 illustrated in FIG. 1 in a sectional schematic representation corresponding to one exemplary embodiment of the present invention. Component 3 has a base body 15, which is at least partially made of a plastic part 16. An electric line 17 is applied to base body 15 by plasma coating. At least one electric line 17 is applied to base body 15. In this exemplary embodiment, electric line 17 is applied directly to a top 18 of base body 15 or of plastic part 16. Electric line 17 is thus directly applied to the electrically insulating material of plastic part 16 or of base body 15 via plasma coating.

In addition, an electrically conductive contact element 19 is provided, which at least partially is inserted or injected into plastic part 16. In this exemplary embodiment, a recess 20, into which a section of contact element 19 is inserted, is provided in plastic part 16. Contact element 19 may be used, for example, as coil pin 19 and be connected to a solenoid 21 of an actuator of component 3.

Electric line 17 is also applied to contact element 19. An electrical connection, i.e., an electrical contact between electric line 17 and contact element 19, is thus obtained.

Contact element 19 illustrated in FIG. 2 has a connecting section 24, onto which electric line 17 is applied by plasma coating.

Depending on the design, component 3 has additional elements. For example, a fuel channel 22 may be provided.

FIG. 3 shows the section of a component 3 illustrated in FIG. 2 corresponding to another exemplary embodiment of the present invention. In this exemplary embodiment, electric line 17 is applied to base body 15 by plasma coating. Furthermore, electrically conductive contact element 19 has a spring clip 25, which is pre-stressed against electric line 17. Spring clip 25 is thus pressed onto a contact surface 26 of electric line 17. The electrical connection between contact element 19 and electric line 17 is thus formed. A certain tolerance and other type of compensation may be ensured in this way. Thermal changes in length may thus be compensated for, for example, since the contact point between spring clip 25 and electric line 17 may move within certain limits on contact surface 26.

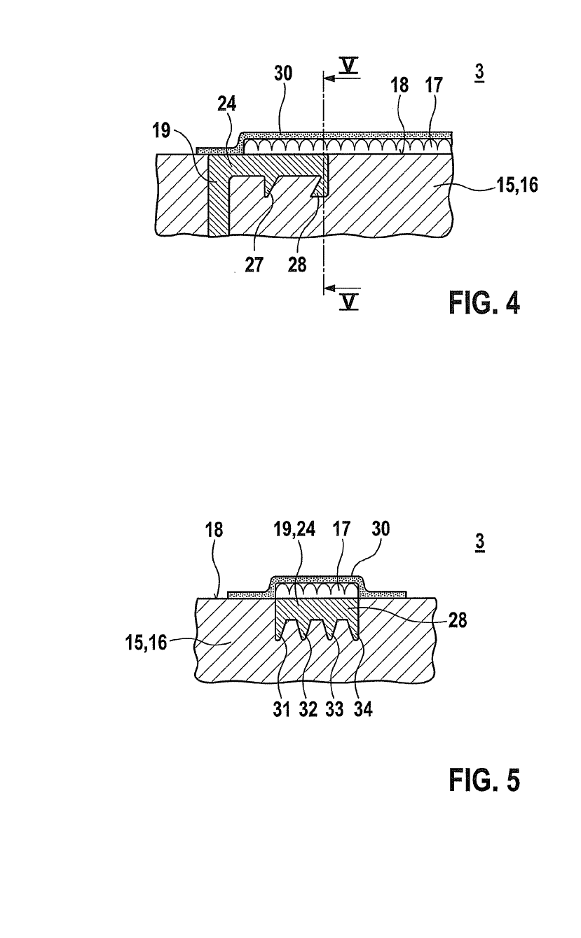

FIG. 4 shows the section of a component 3 illustrated in FIG. 2 corresponding to yet another exemplary embodiment of the present invention. In this exemplary embodiment, electric line 17 is applied to top 18 of base body 15 by plasma coating. Furthermore, contact element 19 is inserted into base body 15. Contact element 19 is also partially coated by plasma coating together with electric line 17. An electrical connection between electric line 17 and contact element 19 is thus formed. In this exemplary embodiment, contact element 19 has claw elements 27, 28, which are connected to plastic part 16 by positive and/or integral connection. Claw elements 27, 28 may be inserted into plastic part 16 via an insulation displacement connection. Claw elements 27, 28 may also be pressed into plastic part 16. A cost-effective design is thus possible.

In addition, a protective layer 30 is provided in this exemplary embodiment. Electric line 17 is coated with electrically insulating protective layer 30 here. Protective layer 30 at least mostly covers electric line 17. This provides protection of electric line 17 against contact, short-circuiting, corrosion, or mechanical wear such as abrasion. Protective layer 30 may be designed as a protective lacquer 30. Extrusion coating using plastic or the like is also possible.

FIG. 5 shows component 3 schematically illustrated in FIG. 4 in a sectional schematic illustration along section line V-V. Claw element 28 has multiple protrusions 31, 32, 33, 34. Protrusions 31 through 34 may be designed as teeth 31 through 34, as claws 31 through 34, or the like. On the one hand, protrusions 31 through 34 facilitate the insertion of contact element 19 into the material of plastic part 16 during manufacture. In addition, the mechanical connection may thus be improved.

Furthermore, these contact elements may be pressed into a slot in the plastic by overpressing or injected at least partially in a form-locked manner.

FIG. 6 shows a wiring diagram for illustrating the electric lines of a fuel injection system 1 corresponding to one exemplary embodiment of the present invention. Fuel injection system 1 includes schematically illustrated fuel distributor 2 and fuel injectors 3, 4, 5, 11. In this exemplary embodiment, electric lines 17A through 17E are applied to fuel distributor 2 by plasma coating. Electric lines 17A through 17D are used here as signal lines or control lines. Furthermore, a shared ground line 17E is formed by electric line 17E. The ground is thus guided to the individual fuel injectors 3, 4, 5, 11 via electric line 17E.

Central plug 10 has contact elements 35A through 35E. Electric lines 17A through 17E are each electrically connected to contact elements 35A through 35E. Since only one electric line 17E is provided to guide the ground to fuel injectors 3, 4, 5, 11, in this exemplary embodiment only five contact elements 35A through 35E, in particular pins 35A through 35E, are required for four fuel injectors 3, 4, 5, 11.

In the exemplary embodiment illustrated in FIG. 6, shared ground line 17E is formed comb-like by plasma coating on base body 6 of fuel distributor 2.

FIG. 7 shows a wiring diagram for illustrating the electric lines of a fuel injection system 1 corresponding to another exemplary embodiment of the present invention. In this exemplary embodiment, electric lines 17A through 17H are applied to fuel distributor 2 by plasma coating. Furthermore, electric lines 17A through 17H are each connected to a contact element 35A through 35H of central plug 10. In this embodiment, both an electric line 17A through 17D as a signal line or control line and an electric line 17E through 17H as a ground line are guided to each fuel injector 3, 4, 5, 11. Therefore, in this exemplary embodiment, eight contact elements 35A through 35H of central plug 10 are required for electrically contacting the four fuel injectors 3, 4, 5, 11.

The mechanical connection of fuel injectors 3, 4, 5, 11 to pipe-shaped base body (rail) 6 may be implemented by a form-locked connection such as plugging or clipping. An integral connection such as injection without sealing elements, in particular without an O-ring, for example, in combination with plastic-metal connections, is possible. Gluing or welding, for example by ultrasonic welding or laser welding, is also possible.

In the case of plasma coating there is the advantage that in the event of subsequent application of the conductive structure, base body 6, which is usually pressurized, or base body 15 is not mechanically weakened. In addition, by controlling the quantity of conductive material, a layer adapted to the needed current carrying capacity may be applied. Overdimensioning, as occurs in the case of current-conducting rails, is thus avoided.

The present invention is not limited to the described exemplary embodiments.

What is claimed is:

1. A component of a fuel injection system, in particular a fuel distributor or a fuel injector, comprising:
a base body on which at least one electric line is provided;
wherein the electric line is applied to the base body by plasma coating.

2. The component as recited in claim 1, wherein the base body is at least partially formed from a plastic part, and further comprising:
an electrically conductive contact element at least partially inserted into the plastic part, the contact element being electrically connected to the electric line.

3. The component as recited in claim 2, wherein the electrically conductive contact element has a connecting section, and the electric line is applied to the connecting section of the electrically conductive contact element by plasma coating for forming the electric connection.

4. The component as recited in claim 3, wherein the connecting section of the contact element has at least one claw element, which is connected to the plastic part in at least one of a form-locked and integral manner.

5. The component as recited in claim 4, wherein one of (a) the claw element is introduced into the plastic part by an insulation displacement connection, and (b) the claw element is pressed into the plastic part.

6. The component as recited in claim 2, wherein the electrically conductive contact element has a spring clip, which is pre-stressed against the electric line for forming the electrical connection.

7. The component as recited in claim 1, wherein the electric line is at least partially coated by an electrically insulating protective layer.

8. The component as recited in claim 1, wherein the base body is at least partially made of at least one electrically insulating material, and the electric line is applied directly to the electrically insulating material by plasma coating.

9. A fuel injection system, in particular for motor vehicles, comprising:
a fuel distributor; and
multiple fuel injectors mounted on the fuel distributor;
wherein the fuel distributor comprises:
a base body; and
at least one associated electric line for each fuel injector, the electric lines being provided on the base body;
wherein the electric lines are applied to the base body of the fuel distributor by plasma coating.

10. The fuel injection system as recited in claim 9, further comprising:
a central plug having a plug base body that is one of (a) extruded onto the base body of the fuel distributor, and (b) integrated with the base body of the fuel distributor;
wherein the electric lines are electrically connected to contact elements of the central plug.

11. The fuel injection system as recited in claim 9, wherein one of the electric lines is used as a shared ground line for the fuel injectors, and the shared ground line is formed in a comb shape on the base body by plasma coating.
